(19) United States
(12) Patent Application Publication
(10) Pub. No.: US 2009/0007732 A1
(43) Pub. Date: Jan. 8, 2009

(54) RECESSED SCREWING DRIVING ASSEMBLY

(76) Inventor: Chih-Ching HSIEH, Taichung City (TW)

Correspondence Address: Chien-Hui Su, P. O. Box 70-121 Taichung, Taichung City, 40899, TW

(21) Appl. No.: 11/772,827

(22) Filed: Jul. 3, 2007

(51) Int. Cl. B25B 23/08

(52) U.S. Cl. 81/120; 81/125; 81/177.85

(57) ABSTRACT

A recessed screwing driving assembly comprises a driving portion having an engaging opening; each apex of the engaging opening being formed as an apex recess which has a concave cambered shape; a middle section of each side of the engaging opening being formed with a middle side; between each middle side and an adjacent apex recess being formed with a first recess and a second recess. The first recess has two straight sides and a concave cambered lower bottom; the two straight sides of the first recess are inclined to the first side and are extended from the first side toward a direction far away from the first side. The slope of the side of the first recess near the apex recess is greater than that of the other side of the first recess. The second recess has a shape like that of the first recess.

### FIELD OF THE INVENTION

The present invention relates to spanners, and particularly to a recessed screwing driving assembly which can prevent the rounding of the screwing object and can effectively drive a screwing object.

### BACKGROUND OF THE INVENTION

Spanners are generally used tool in working and daily life. The spanners are used to drive a screwing object. Generally, if a screwing object is driven many times, it will be rounded as the apexes. The rounded screwing object will cause some troubles as it is driven.

Thereby some improvement structures are developed for improving the rounding of the screwing object and for driving a screwing object without rounding the object.

In one improvement structure, the spanner has an engaging opening which is a polygonal opening. The apex of the opening is formed as a concave cambered recess so that as the screwing object is installed in the engaging opening; the apex of the screwing object will be received in the recess and thus in driving, the apex will not round.

However such a structure has straight sides at the polygonal opening. In using, the straight side will rub the side of the screwing object. For a long time, the edge between the recess and the straight side will round and the side will wear so that the stress from the spanner cannot be effectively transferred to the screwing object.

In another improvement structure, the side of the polygonal opening is formed with a plurality of cambered convexes. However the cambered convex portions point-contacts with the side of the screwing object. Thus large stresses are applied to few points of the sides of the engaging opening of the spanner which will make the structure of the driving portion of the spanner weaken.

Thus all above mentioned prior arts have defects in applications. Thus there is an eager demand for a novel design which can improve the defects in the prior art.

### SUMMARY OF THE INVENTION

Accordingly, the primary object of the present invention is to provide a recessed screwing driving assembly which can prevent the rounding of the screwing object and can effectively drive a screwing object.

To achieve above objects, the present invention provides a recessed screwing driving assembly, comprising: a driving portion having an engaging opening; each apex of the engaging opening being formed as an apex recess which has a concave cambered shape; a middle section of each side of the engaging opening being formed with a middle side; between each middle side and an adjacent apex recess being formed with a first recess and a second recess; the first recess being near the apex recess and the second recess being near the middle side; a first side formed between the apex recess and the first recess; and a second side formed between the second recess and the middle side. The middle side, the first side and second side are straight sides and are collinear. The first recess has two straight sides and a concave cambered lower bottom; the two straight sides of the first recess are inclined to the first side and are extended from the first side toward a direction far away from the first side. The slope of the side of the first recess near the apex recess with respect to the first side is greater than that of the other side of the first recess. The second recess has a shape like that of the first recess.

The various objects and advantages of the present invention will be more readily understood from the following detailed description when read in conjunction with the appended drawing.

### BRIEF DESCRIPTION OF THE DRAWINGS

FIG. 1 is a perspective view of the recessed screwing driving assembly of the present invention.

FIGS. 2 to 3 show the first application state of the present invention.

FIGS. 4 to 5 show the second application state of the present invention.

FIGS. 6 to 7 show the third application state of the present invention.

FIGS. 8 to 9 show the fourth application state of the present invention.

FIGS. 10 to 11 show the fifth application state of the present invention.

FIG. 12 to FIG. 14 show the applications of the present invention, wherein the present invention are used in a ratchet spanner, a socket, and a general spanner, respectively.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

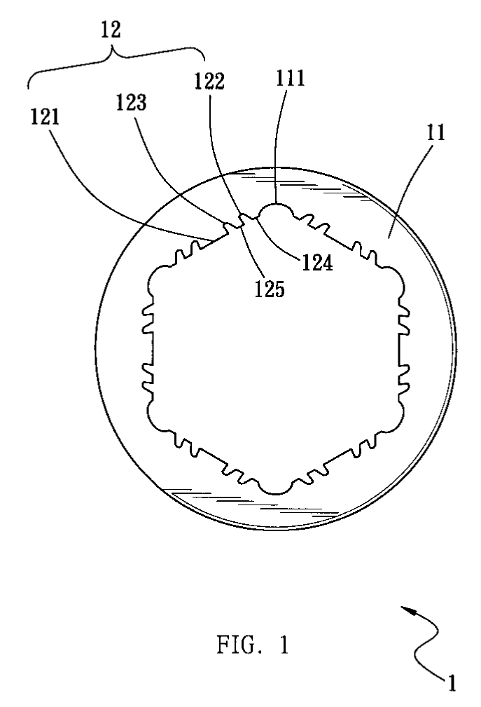

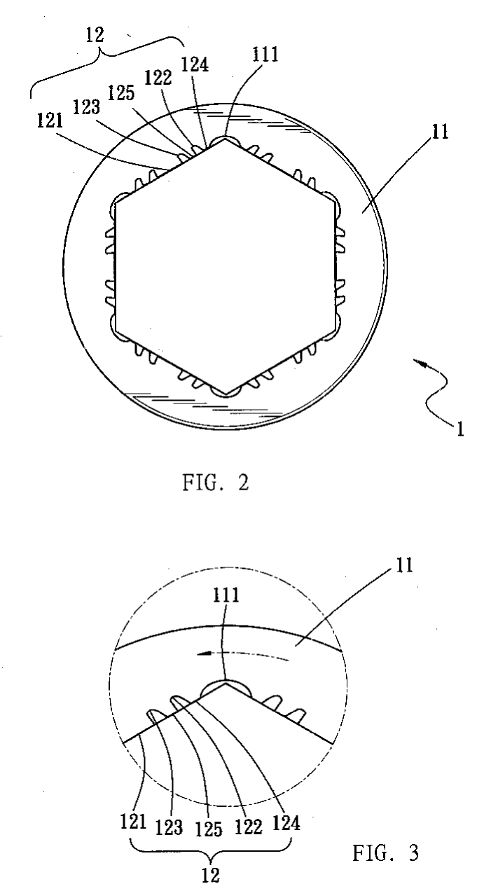

Referring to FIGS. 1 and 2B, the first embodiment of the present invention is illustrated. The present invention has the following elements.

A driving portion 1 has an engaging opening 11. The engaging opening 11 has an approximate hexagonal shape.

Each apex of the hexagonal engaging opening 11 is formed as an apex recess 111 which has a concave cambered shape.

The engaging opening 11 has six sides. A middle section of each side of the engaging opening 11 is formed with a middle side 121. Between each middle side 121 and an adjacent apex recess 111 is formed with a first recess 122 and a second recess 123. The first recess 122 is near the apex recess 111 and the second recess 123 is near the middle side 121.

A first side 124 is formed between the apex recess 111 and the first recess 122.

A second side 125 is formed between the second recess 123 and the middle side 121.

The middle side 121, first side 124 and second side 125 are straight sides and are collinear.

The first recess 122 has two straight sides and a concave cambered lower bottom. The two straight sides of the first recess 122 are inclined to the first side 124 and are extended from the first side 124 toward a direction far away from the first side 124. The slope of the side of the first recess 122 near the apex recess 111 with respect to the first side 124 is greater than that of the other side of the first recess 122.

The second recess 123 has two straight sides and a concave cambered lower bottom. The two straight sides of the second recess 123 are inclined to the second side 125 and are extended from the second side 125 toward a direction far away from the second side 125. The slope of the side of the second recess 123 near the apex recess 111 with respect to the second side 125 is greater than that of the other side of the second recess 123.

In the present invention, it is permissible that the first recesses 122 and second recesses 123 at two sides of one middle side 121 are symmetrical.

Referring to FIGS. 2 to 5, the effect of the present invention in application will be described herein.

In FIGS. 2 and 3, it is illustrated that when the size of a hexagonal screwing object has a size exactly matching to the size of the engaging opening 11. In driving operation, the screwing object will tightly engage with the engaging opening 11 of the driving portion 1 of the spanner so that it will not slide in the engaging opening 11.

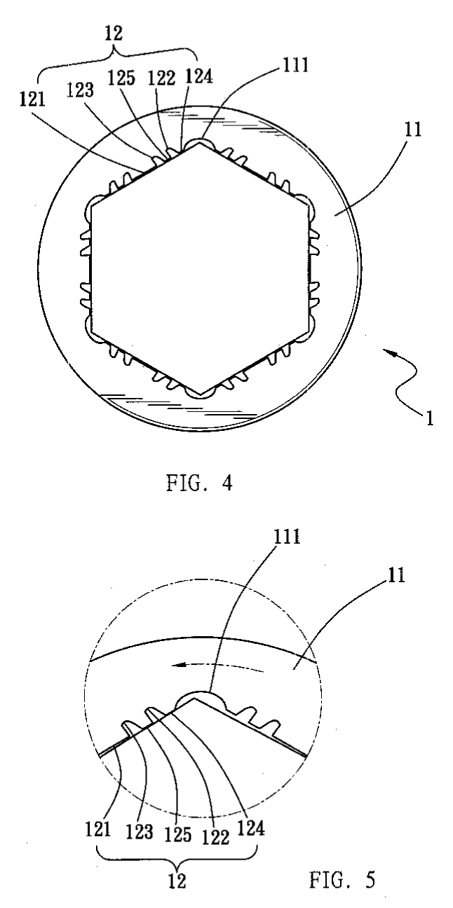

With referring to FIGS. 4 and 5, if the hexagonal screwing object is slightly smaller than the side of the engaging opening 11, in driving, the screwing object has a little shift from the engaging opening 11. The side of the screwing object contacts the side of the engaging opening 11 at the second side 125 and the second side 125. Because the apex recesses 111 of engaging opening 11, the object will not be rounded at the apexes so as to retain the structure of the screwing object.

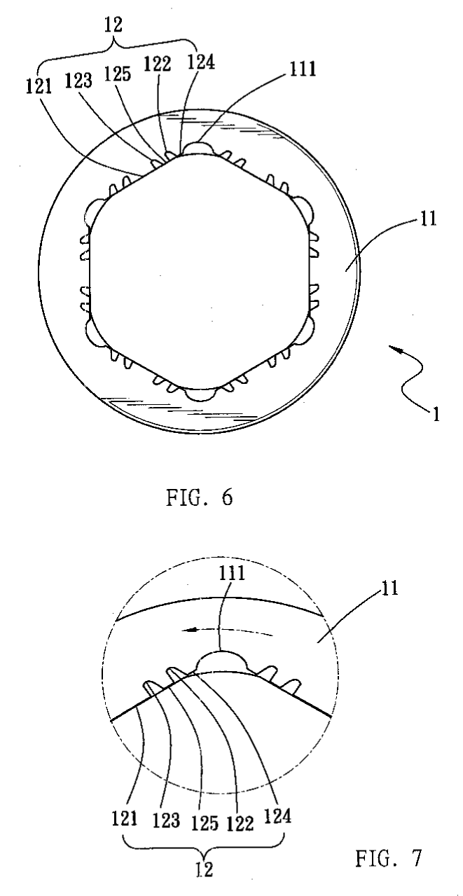

Referring to FIGS. 6 and 7, if the screwing object has rounded at the apexes. In driving, see FIG. 7, the screwing object will shift from a normal position, while the side of the screwing object will contact the side of the engaging opening 11 at the second side 125 and the middle side 121

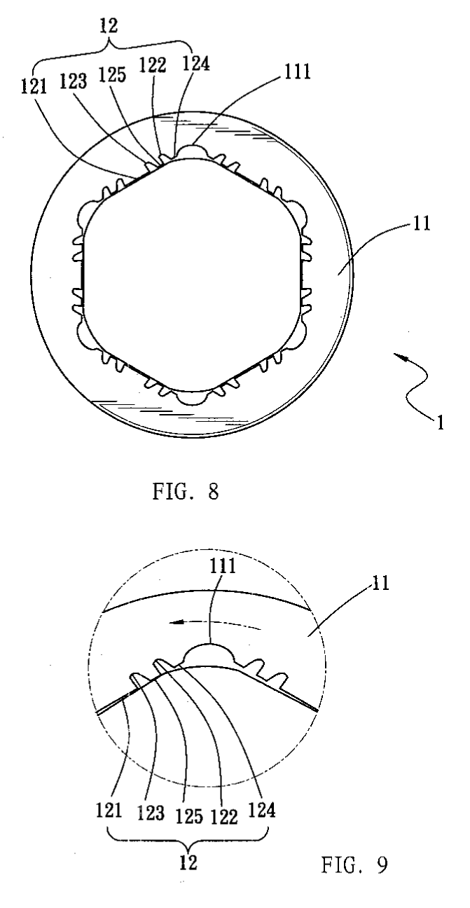

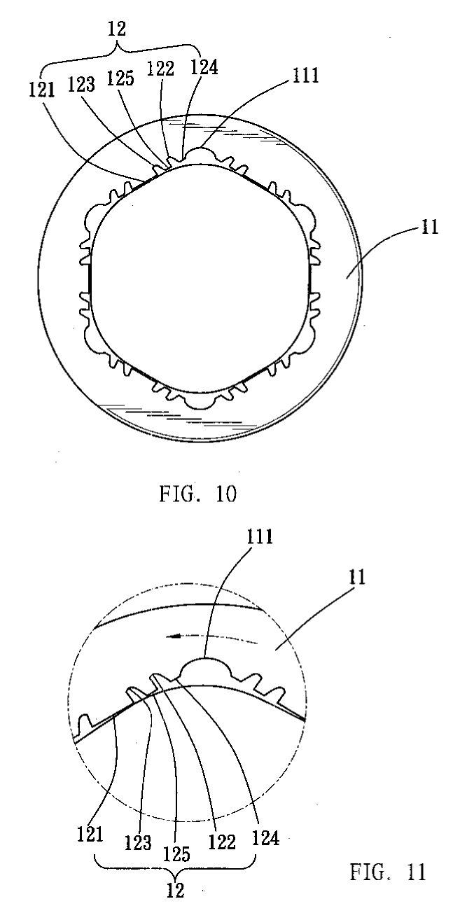

With referring to FIGS. 8 and 9, if the screwing object has rounded at the apexes with an extent greater than that in FIGS. 6 and 7. In driving, see FIG. 9, the screwing object will shift from a normal position, while the side of the screwing object will contact the side of the engaging opening 11 at the first side 124.

With referring to FIGS. 10 and 11, if the screwing object has rounded at the apexes with an extent greater than that in FIGS. 8 and 9. In driving, see FIG. 11, the screwing object will shift from a normal position, while the side of the screwing object will contact the side of the engaging opening 11 at a part of the middle side 121.

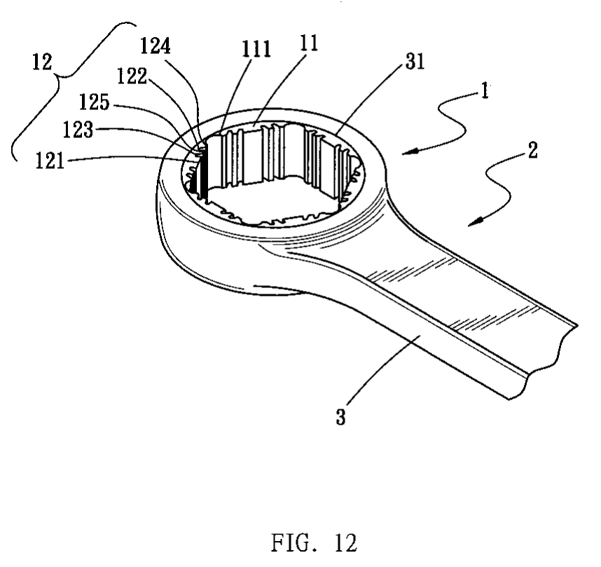

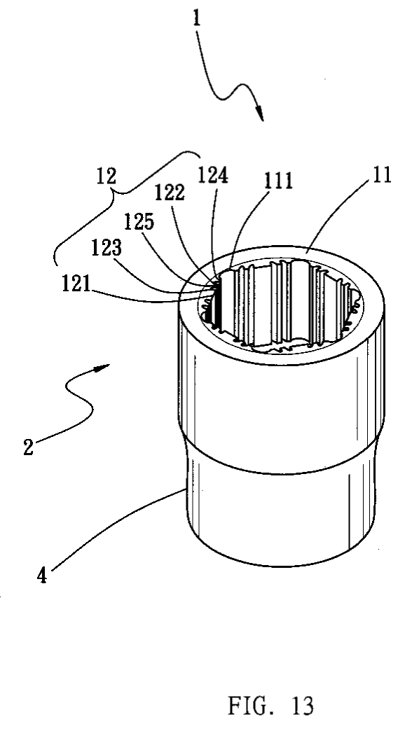

FIGS. 12 to 14 show the applications of the present invention.

In FIG. 12, it is illustrated that the present invention is applied to a ratchet spanner 3. In this embodiment, those identical to the above embodiment will not be further described herein. Only those different from above embodiment are described. The ratchet spanner 3 has a handle 2 and a driving portion 1. The driving portion 1 has a ratchet wheel 31. The ratchet wheel 31 has the engaging opening 11 of the present invention.

FIG. 13 shows that the present invention is used to a socket 1. In this embodiment, those identical to the above embodiment will not be further described herein. Only those different from above embodiment are described. The socket has a large end 2 and a reduced end 4. The larger end 2 has the engaging opening 11 of the present invention.

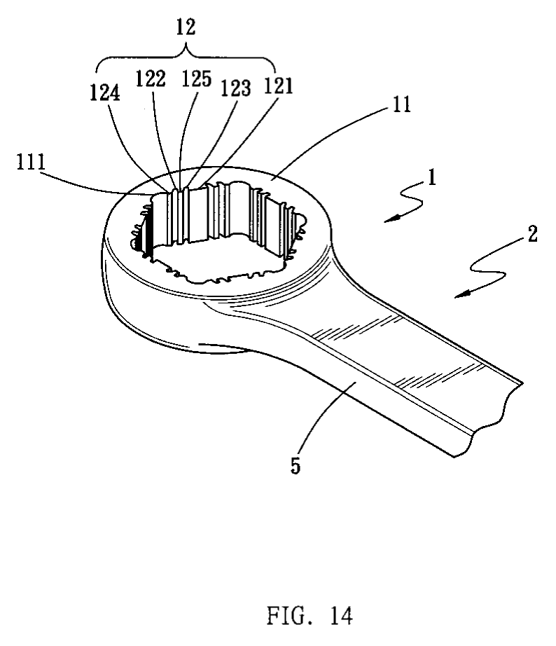

FIG. 14 shows that the present invention is applied to a spanner 2. In this embodiment, those identical to the above embodiment will not be further described herein. Only those different from above embodiment are described. The spanner has a handle 5 and a driving portion 1. The driving portion 1 has the engaging opening 11 of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A recessed screwing driving assembly, comprising:
a driving portion having an engaging opening, wherein the engaging opening has a hexagonal shape with six apexes and six sides;
each apex of the engaging opening being formed as an apex recess which has a concave cambered shape;
a middle section of each side of the engaging opening being formed with a middle side; between each middle side and an adjacent apex recess being formed with a first recess and a second recess; the first recess being near the apex recess and the second recess being near the middle, wherein the first recesses and the second recesses at two sides of one middle side are symmetrical, the first recess having two straight sides and a concave cambered lower bottom, the two straight sides of the first recess being inclined to the first side and extending from the first side toward a direction far away from the first side, the second recess having two straight sides and a concave cambered lower bottom, the two straight sides of the second recess being inclined to the second side and extending from the second side toward a direction far away from the second side;
a first side formed between the apex recess and the first recess; and
a second side formed between the second recess and the middle side, wherein the middle side, the first side and the second side are straight sides and are collinear.

2. (canceled)

3. (canceled)

4. The recessed screwing driving assembly as claimed in claim 1, wherein the slope of the side of the first recess near the apex recess with respect to the first side is greater than that of the other side of the first recess.

5. (canceled)

6. The recessed screwing driving assembly as claimed in claim 1, wherein the slope of the side of the second recess near the apex recess with respect to the second side is greater than that of the other side of the second recess.

7. (canceled)

8. (canceled)

9. (canceled)

10. (canceled)

11. (canceled)
